(19) United States
(12) Patent Application Publication
(10) Pub. No.: US 2012/0013834 A1
(43) Pub. Date: Jan. 19, 2012

(54) LIQUID CRYSTAL FILM

(75) Inventors: Su Young RYU, Daejeon (KR); Byoung Kun Jeon, Daejeon (KR); Moon Soo Park, Daejeon (KR); Sin Young Kim, Daejeon (KR); Hyuk Yoon, Gyeonggi-do (KR); Hyoung Gu Kang, Chungchungbuk-do (KR); Sang Jun Yoon, Seoul (KR)

(73) Assignee: LG CHEM, LTD., Seoul (KR)

(21) Appl. No.: 13/185,311

(22) Filed: Jul. 18, 2011

(30) Foreign Application Priority Data
Jul. 16, 2010 (KR) 10-2010-0069220
Nov. 9, 2010 (KR) 10-2010-0111021

(51) Int. Cl. G02F 1/1337; C09K 19/56; C08F 2/50; G02F 1/13

(52) U.S. Cl. 349/123; 349/194; 428/1.2; 428/1.25; 428/1.26; 427/508

(57) ABSTRACT

Provided are a liquid crystal film, a method of manufacturing a liquid crystal film, a method of controlling an average tilt angle of the liquid crystal film, a polarizing plate, and a liquid crystal display device. A liquid crystal film that has excellent properties including durability and an optical property and is capable of being effectively used for various uses may be provided. In addition, the physical properties of the liquid crystal film may be easily controlled according to a desired use.

### CROSS-REFERENCE TO RELATED APPLICATION

This application claims priority to and the benefit of Korean Patent Application Nos. 10-2010-0069220, filed on Jul. 16, 2010, and 10-2010-0111021, filed on Nov. 9, 2010 the disclosure of which is incorporated herein by reference in its entirety.

### BACKGROUND

1. Field of the Invention

The present invention relates to a liquid crystal film, a method of manufacturing the same, a method of controlling an average tilt angle, a polarizing plate, and a liquid crystal display device.

2. Discussion of Related Art

There is a consistent demand for manufacturing a thinner, lighter and larger liquid crystal display (LCD) device or plasma display panel (PDP), and research on improving display uniformity, a contrast ratio and a viewing angle in order to realize a higher-quality image is also in progress.

An optical film including a retardation film or a viewing angle compensation film may be used to reduce a color change of a display device, ensure a viewing angle, and improve brightness.

An elongated film made by elongating a polymer film which then becomes optically anisotropic is known as such an optical film, and a method of using the optical anisotropy of a liquid crystal film manufactured by curing a polymerizable liquid crystal compound is also known.

Liquid crystal molecules may be classified into rod-shaped liquid crystals and disc-shaped liquid crystals according to their shapes. The rod-shaped liquid crystals are present in various alignment types including homogeneous, homeotropic, tilted, splay or cholesteric types. Therefore, an optical property which cannot be obtained from the elongated film may be exhibited. For example, when various liquid crystal alignment characteristics are provided by applying a polymerizable liquid crystal compound to an elongated film, more various physical properties can be ensured.

A liquid crystal film is usually manufactured by forming an alignment layer by applying an alignment agent such as polyimide or polyvinyl alcohol to a substrate, providing an aligning property by rubbing it in a predetermined direction, and applying and aligning a polymerizable liquid crystal compound to the alignment layer. However, due to a lack of adhesive strength to a liquid crystal layer, a rubbed alignment layer has a problem of detaching or contracting a liquid crystal layer in a severe environment including high temperature or high humidity. Furthermore, according to the rubbing method, static electricity or scratching may be easily caused due to friction during rubbing, and fine dust caused from a rubbing fabric may also be a problem.

To solve the problems of the rubbing method, a non-contact alignment method, for example, a photo-alignment method using light irradiation, is known. As examples of the photo-alignment method, a method of using photo-dimerization of an alignment layer material used in the photo-alignment method, such as a cinnamate moiety, a coumarine moiety or a chalcone moiety, a method of using photo-isomerization of a polymer including an azobenzene moiety, and a method of using photo-dissociation of a polyimide are known.

However, these methods also have problems of poor thermal or optical stability of the alignment layer, and contamination caused by a degradation product or unreacted material. It is common to form an alignment layer on a plastic substrate in order to manufacture a retardation film, a viewing angle compensation film or a brightness improving film using a polymerizable liquid crystal compound, but the photo-alignment method is limited in kinds of substrates that can be used.

In addition, an LCD device is classified according to various modes including twisted nematic (TN), super twisted nematic (STN), vertical alignment (VA) and in-plane switching (IPS) modes according to arrangement of liquid crystal molecules in a liquid crystal panel.

Accordingly, each liquid crystal panel has original liquid crystal arrangement, and thus is different from others in optical anisotropy.

To compensate for the optical anisotropy of the liquid crystal panel, it is necessary to develop a film having an optimized optical physical property according to a kind of the liquid crystal panel.

### SUMMARY OF THE INVENTION

The present invention is directed to providing a liquid crystal film, a method of manufacturing a liquid crystal film, a method of controlling an average tilt angle of a liquid crystal film, a polarizing plate, and a liquid crystal display (LCD) device.

In one aspect, a liquid crystal film includes: a substrate; an alignment layer which is present on the substrate and which is a reaction product of a mixture including a photo-alignment polymer, a reactive compound having at least one functional group capable of reacting with the photo-alignment polymer and a photoinitiator; and a liquid crystal layer which is present on the alignment layer and which includes a liquid crystal molecule.

Hereinafter, the liquid crystal film will be described in detail.

As a substrate for the liquid crystal film, a substrate conventionally used in manufacturing a liquid crystal film may be used. For example, as a plastic substrate which is used in the manufacture of the liquid crystal film, an acrylic substrate, a cycloolefin polymer (COP) substrate, a cellulose substrate such as a triacetyl cellulose (TAC) substrate or a polycarbonate substrate may be used.

In one embodiment, the substrate may be an acrylic substrate.

As the acrylic substrate, a substrate including an acrylic polymer including a (meth)acrylic monomer in polymerized form may be used. The substrate may have a film or sheet shape. In the specification, a “substrate including a certain component” may mean a substrate manufactured by applying a raw material including the certain component to a conventional film or sheet forming method such as extrusion or casting.

In the specification, the term “(meth)acrylic monomer” may include a compound in which a double bond is present between a carbonyl group included in an ester group and conjugated carbons. The compound may or may not be substituted, and when the compound is substituted, a kind of a substituent is not particularly limited. Examples of the substituent may include a halogen group, a hydroxyl group, an epoxy group, acryloyl group, a methacryloyl group, an isocyanate group, a thiol group, an alkoxy group and a monovalent hydrocarbon group. The (meth)acrylic monomer may include an acrylate compound and a derivative thereof, for example, alkyl acrylate, alkyl methacrylate or alkyl butacrylate.

In one embodiment, the (meth)acrylic monomer may be a compound represented by the following Formula 1.

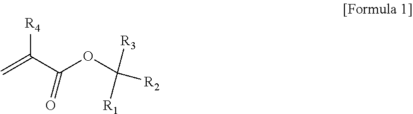

In Formula 1, R₁, R₂ and R₃ are independently a hydroxyl group, an epoxy group, an isocyanate group, an alkoxy group or a monovalent hydrocarbon group, and R₄ is a hydrogen atom or an alkyl group.

In the specification, unless particularly defined otherwise, the term “alkoxy group” may include a linear, branched or cyclic alkoxy group having 1 to 12 carbon atoms, preferably 1 to 8, more preferably 1 to 4 carbon atoms, and an example of the alkoxy group may include a methoxy group, an ethoxy group, a propoxy group, an isopropoxy group, a butoxy group, an isobutoxy group or a tert-butoxy group.

In addition, in the specification, the term “monovalent hydrocarbon group” includes a monovalent moiety induced from a compound consisting of carbon and hydrogen or a compound in which at least one hydrogen of the compound is substituted with a certain substituent, and unless particularly defined otherwise, an example of the monovalent hydrocarbon group may include an alkyl group, an alkenyl group, an alkynyl group or an aryl group.

In the specification, the term “alkyl group” may include, unless particularly defined otherwise, a linear, branched or cyclic alkyl group having 1 to 12, preferably 1 to 8, and more preferably 1 to 4 carbon atoms, and an example of the alkyl group may be a methyl group, an ethyl group, a propyl group, an isopropyl group, a butyl group, an isobutyl group, a tert-butyl group, a pentyl group, a neopentyl group, a cyclohexyl group, a hexyl group, an octyl group, a nonyl group or a decyl group.

In addition, in the specification, the term “alkenyl group” may include, unless particularly defined otherwise, a linear, branched or cyclic alkenyl group having 2 to 12, preferably 2 to 8, and more preferably 2 to 4 carbon atoms, and an example of the alkenyl group may be a vinyl group, an aryl group, a prophenyl group, an isoprophenyl group, a butenyl group, a hexenyl group, a cyclohexenyl group or an octenyl group.

In addition, in the specification, the term “alkynyl group” may include, unless particularly defined otherwise, a linear, branched or cyclic alkynyl group having 2 to 12, preferably 2 to 8, and more preferably 2 to 4 carbon atoms, and an example of the alkynyl group may be an ethynyl group, a propynyl group or a butynyl group.

In addition, in the specification, the term “aryl group” may include, unless particularly defined otherwise, an aralkyl group or an arylalkyl group, and may mean a monovalent moiety derived from a compound including a benzene ring or a structure in which at least two benzene rings are condensed, or a derivative thereof. The aryl group may include an aryl group having 6 to 22, and preferably 6 to 16 carbon atoms. An example of the aryl group may include a phenyl group, a phenylethyl group, a phenylpropyl group, a benzyl group, a tolyl group, a xylyl group or a naphthyl group.

Each substituent described above may be optionally substituted with at least one substituent, and examples of the substituent may include a halogen group, a hydroxy group, an epoxy group, an acryloyl group, a methacryloyl group, an isocyanate group, a thiol group, an alkoxy group and a monovalent hydrocarbon group.

In Formula 1, at least one of R₁, R₂ and R₃ may be an epoxy group. Preferably, R₁, R₂ and R₃ may be independently hydrogen, an epoxy group or an alkyl group, and more preferably, hydrogen or an alkyl group having 1 to 12 carbon atoms.

Also, in Formula 1, R₄ may be hydrogen or an alkyl group having 1 to 6 carbon atoms, and preferably be hydrogen or an alkyl group having 1 to 4 carbon atoms.

An example of the compound of Formula 1 may be, but is not limited to, methyl acrylate, ethyl acrylate, methyl methacrylate, ethyl methacrylate, methyl ethacrylate or ethyl ethacrylate, and preferably methyl methacrylate (MMA).

In one embodiment, the acrylic polymer may further include an aromatic vinyl monomer in polymerized form. As the aromatic vinyl monomer, a monomer having an aromatic moiety and a vinyl group or a monomer having a structure in which the aromatic moiety and/or the vinyl group of the monomer is substituted with at least one substituent such as an alkyl group, and preferably an alkyl group having 1 to 5 carbon atoms, or a halogen group, may be used. An example of the aromatic vinyl monomer may include a styrene monomer. In the specification, the term “styrene monomer” may include a styrene or a derivative thereof, and an example of the styrene monomer may be styrene, α-methyl styrene, p-methyl styrene or vinyl toluene.

In one embodiment, the acrylic polymer may further include an acid anhydride in polymerized form. The acid anhydride may be a carboxylic acid anhydride. For example, a monovalent or polyvalent carboxylic acid anhydride may be used. In one embodiment, the acid anhydride may be maleic acid anhydride or derivative thereof. For example, as the acid anhydride, a compound represented by the following Formula 2 may be used.

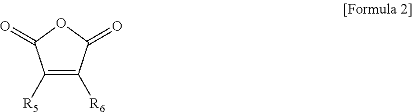

In Formula 2, R₅ and R₆ are independently hydrogen or an alkyl group.

In one embodiment, the acrylic polymer may further include a cyclic monomer in polymerized form. In the specification, the term “cyclic monomer” means, unless particularly defined otherwise, a monomer including a ring structure and a copolymerizable functional group in a molecule structure. As the cyclic monomer, anhydrous maleic acid, maleimide, glutaric acid anhydride, glutarimide, lactone, lactame or derivative thereof may be used. In one embodiment, the cyclic monomer may be, but is not limited to, a maleimide monomer, for example, N-cyclohexyl maleimide, N-phenyl maleimide, N-methyl maleimide, N-butyl maleimide or derivative thereof, and preferably N-cyclohexyl maleimide or a derivative thereof.

An example of the acrylic polymer may be a homopolymer or copolymer of the (meth)acrylic monomer; a copolymer of the (meth)acrylic monomer and the aromatic vinyl monomer; a copolymer of the (meth)acrylic monomer, the aromatic vinyl monomer and the acid anhydride; or a copolymer of the (meth)acrylic monomer and the cyclic monomer.

A ratio of each of said monomers in the polymer is not particularly limited, and may be controlled according to a desired purpose. However, when the cyclic monomer is included in a polymer, it may be preferable to control the ratio of the cyclic monomer in the polymer to be approximately 1 to 50 weight % in order to reduce a haze of a substrate.

In one embodiment, the acrylic substrate may further include at least one selected from the group consisting of an aromatic resin having an aromatic backbone and a hydroxyl group; a styrene resin and a copolymer of the styrene monomer and the cyclic monomer.

As an aromatic resin, a resin that includes an aromatic structure in a polymer backbone and a hydroxyl group and that has a number average molecular weight (Mn) of 1,500 to 2,000,000 g/mol may be used. In one embodiment, the aromatic resin may be a phenoxy resin. The phenoxy resin may includes a resin having a structure in which at least one oxygen radical is bound to a benzene ring.

In one embodiment, the aromatic resin may be a resin including a unit represented by the following Formula 3.

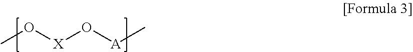

In Formula 3, X is a bivalent moiety induced from an aromatic compound, and A is an alkylene group or an alkylidene group substituted with at least one hydroxyl group.

In the above, the term “bivalent moiety induced from the aromatic compound” may mean a bivalent moiety derived from a compound including at least one benzene ring or a structure in which at least two benzene rings are condensed or derivative thereof. For example, the bivalent moiety may include a compound induced from an aromatic compound having 6 to 22 carbon atoms, and preferably 6 to 16 carbon atoms.

In one embodiment, the bivalent moiety may be a moiety induced from a compound represented by any one of the following Formulas 4 to 6.

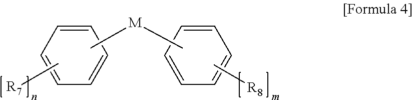

In Formula 4, M is a direct bond, an alkylene or alkylidene, R₇ and R₈ may be independently hydrogen, an alkyl group or an alkenyl group, and n and m are numbers of R₇ and R₈ substituted to the benzenes, respectively, and are independently a number of 1 to 5.

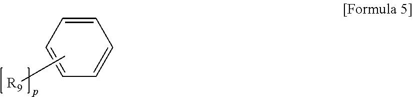

In Formula 5, R₉ is independently hydrogen, an alkyl group or an alkenyl group, and p is a number of R₉ substituted to the benzene ring, and is a number of 1 to 6.

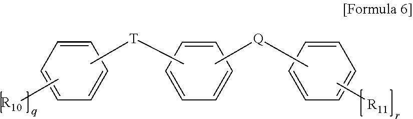

In Formula 6, T and Q are independently a direct bond, an alkylene or an alkylidene, R₁₀ and R₁₁ are independently hydrogen, an alkyl group or an alkenyl group, and q and r are numbers of R₁₀ and R₁₁ substituted to the benzenes, respectively, and are independently a number of 1 to 5.

In Formulas 5 and 6, the term “direct bond” means that there is no atom in a position represented by M, T or Q, and two benzene rings are directly bound to each other.

In the specification, the term “alkylene or alkylidene group” may mean, unless particularly defined otherwise, a linear, branched or cyclic alkylene or alkylidene group having 1 to 20, 1 to 16, 1 to 12, 1 to 8 or 1 to 4 carbon atoms.

In Formulas 5 and 6, the alkylene group may mean a linear or branched alkylene group having 1 to 6 carbon atoms, and the alkylidene group may mean a cycloalkylidene group having 3 to 20 carbon atoms.

An aromatic compound represented by any one of Formulas 4 to 6 may be, but is not limited to, any one of compounds represented by Formulas 7 to 14.

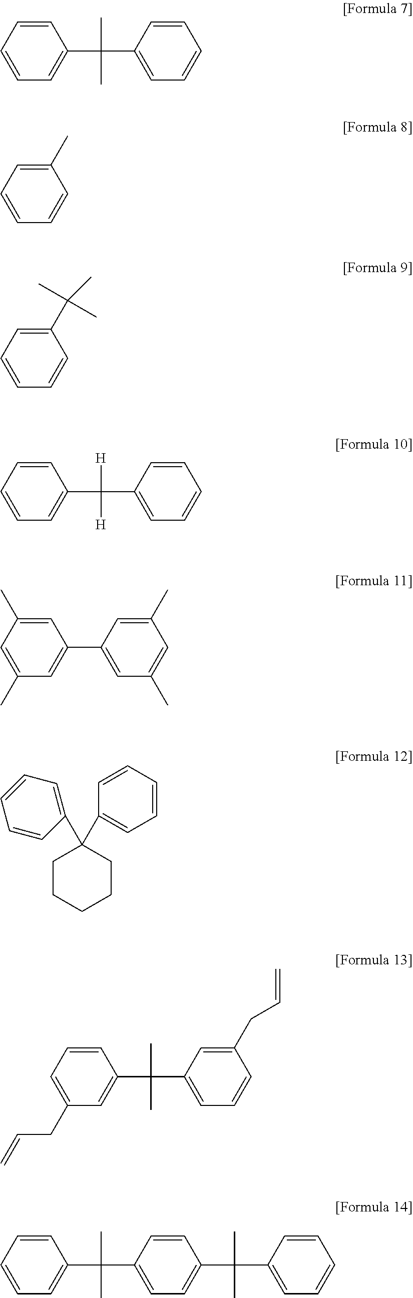

In one embodiment, the unit of Formula 3 may be a unit represented by the following Formula 15.

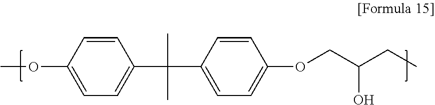

The aromatic resin may include at least one kind of the unit represented by Formula 3, and specifically may include 5 to 10,000 of at least one kind of the unit represented by Formula 3, preferably 5 to 7,000 of at least one kind of the unit represented by Formula 3 and more preferably 5 to 5,000 of at least one kind of the unit represented by Formula 3. When at least two kinds of the units represented by Formula 3 are included, these units may be included randomly, alternatively or in a block type.

The terminal end of the aromatic resin including the unit of Formula 3 may be a hydroxyl group.

In case where the acrylic substrate further includes the aromatic resin, the substrate may include 40 to 99 parts by weight of the acrylic polymer and 1 to 60 parts by weight of the aromatic resin, and preferably, 70 to 98 parts by weight of the acrylic polymer and 2 to 30 parts by weight of the aromatic resin.

In the specification, unless particularly defined otherwise, the unit “part(s) by weight” may mean a weight ratio of each component.

In addition, the styrene resin may be a homopolymer or copolymer of the above-mentioned styrene monomer, and the copolymer of the styrene monomer and a cyclic monomer may be a copolymer of the above-mentioned styrene monomer and a cyclic monomer. A ratio of the cyclic monomer in the copolymer of the styrene monomer and the cyclic monomer may be approximately 1 to 99 weight %, preferably approximately 1 to 70 weight %, and more preferably approximately 5 to 60 weight %.

In case where the acrylic substrate further includes the aromatic resin and the styrene resin or the copolymer of the styrene monomer and the cyclic monomer along with the acrylic polymer, the acrylic substrate may include 50 to 99 parts by weight of the acrylic polymer, 0.5 to 40 parts by weight of the aromatic resin and 0.5 to 30 parts by weight of the styrene resin or the copolymer of the styrene monomer and the cyclic monomer, and preferably, 75 to 98 parts by weight of the acrylic monomer, 1 to 30 parts by weight of the aromatic resin and 1 to 20 parts by weight of the styrene resin or the copolymer of the styrene monomer and the cyclic monomer.

The acrylic substrate may be manufactured by applying a raw material, which is prepared by suitably mixing the above-mentioned components according to a purpose, to a process such as extrusion or casting.

In the film, the alignment layer present on the substrate may be a reaction product of a mixture that includes a photo-alignment polymer, a reactive compound and a photoinitiator. For example, the alignment layer may be obtained by reacting the mixture by irradiating with light, preferably, a polarized UV ray.

The photo-alignment polymer may mean a compound that is aligned by, for example, photo-isomerization, photo-dissociation or photo-dimerization by light irradiation and then exhibits the liquid crystal aligning ability, and preferably a polymer exhibiting the liquid crystal aligning ability through the photo-dimerization by irradiation of polarized ultraviolet (UV) ray.

In the specification, the term “liquid crystal aligning ability” may mean ability to align a liquid crystal molecule, a liquid crystal compound or a precursor thereof adjacent to the alignment layer, the photo-alignment polymer or the reaction product of the polymer in a predetermined direction.

Various photo-alignment polymers are known in the art, and such polymers may be used in the liquid crystal film.

In one embodiment, the photo-alignment polymer may be a norbonene photo-reactive polymer having a cinnamate moiety, a photo-reactive polymer including a unit of the following Formula 16 or a photo-reactive polymer including a unit of the following Formula 17.

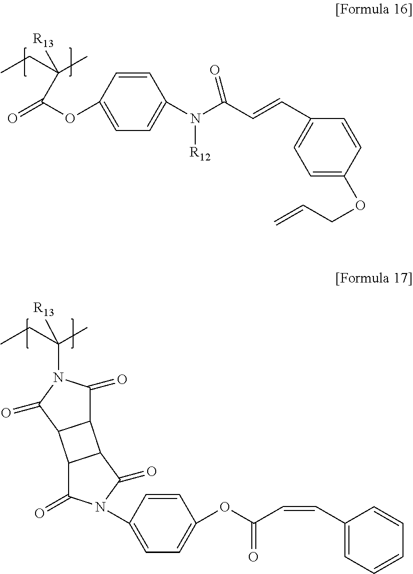

In Formulas 16 and 17, R₁₂ and R₁₃ are independently hydrogen or an alkyl group.

The photo-reactive polymer may, for example, have a number average molecular weight of approximately 10,000 g/mol or 500,000 g/mol. The unit represented by Formulas 16 or 17 may also be substituted with at least one substituent, and an example of the substitutent may be a halogen, a hydroxyl group, an epoxy group, an acryloly group, a methacryloly group, an isocyanate group, a thiol group, an alkoxy group or a monovalent hydrocarbon group.

In one embodiment, as the photo-alignment polymer, the norbonene photo-reactive polymer including a cinnamate moiety may be used, and the photo-reactive polymer may include, for example, a unit represented by the following Formula 18.

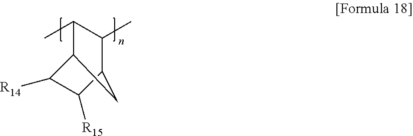

In Formula 18, n is a number of 50 to 5,000, and R₁₄ and R₁₅ are independently hydrogen, a halogen, an alkyl group or a moiety represented by the following Formula 19. At least one of R₁₄ and R₁₅ is a moiety represented by the following Formula 19.

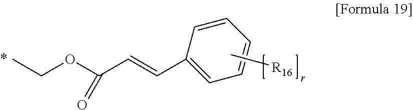

In Formula 19, R₁₆ is independently hydrogen, a halogen, an alkyl group, an alkoxy group or an allyloxy group, and r is a number of R₁₆ represented in a benzene ring, and is a number of 1 to 5.

In Formula 19, a symbol “*” may mean that a portion represented by the symbol is connected to a structure of Formula 18.

In Formula 18, n may be 50 to 3,000, and preferably 50 to 1,500.

Also, in Formula 18, R₁₄ and R₁₅ may be independently hydrogen, an alkyl group or the moiety represented by Formula 19 and at least one of R₁₄ and R₁₅ may be the moiety represented by Formula 19, and preferably hydrogen, an alkyl group having 1 to 6 carbon atoms or the moiety represented by Formula 19 and at least one of R₁₄ and R₁₅ may be the moiety represented by Formula 19.

In Formula 19, R₁₆ may be hydrogen, a halogen, an allyloxy group or an alkoxy group, preferably, hydrogen, a chloride, a bromine, an allyloxy, or an alkoxy having 1 to 6 carbon atoms, and more preferably, hydrogen or an alkoxy having 1 to 6 carbon atoms.

Examples of the photo-reactive polymer including the unit of Formula 18 may include, but are not limited to, polynorbonene cinnamate, polynorbonene alkoxy cinnamate (herein, the alkoxy group may be an alkoxy having 1 to 20 carbon atoms), polynorbonene allyloxy cinnamate, polynorbonene fluorinated cinnamate, polynorbonene chlorinated cinnamate and polynorbonene dicinnamate.

In one embodiment, the photo-reactive polymer including the unit of Formula 18 may include, but is not limited to, at least one of units represented by Formulas 20 to 25.

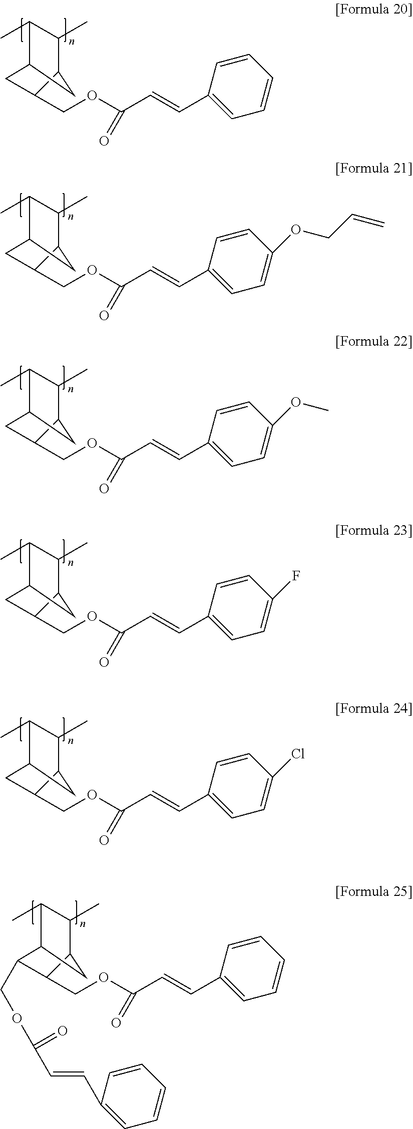

In Formulas 20 to 25, n is the same as defined in Formula 18.

The reactive compound included in the mixture is a compound having at least one functional group capable of reacting with the photo-alignment polymer, and the reactive compound may include at least two functional groups, preferably 2 to 20 functional groups, more preferably 4 to 10 functional groups, and most preferably 4 to 8 functional groups. The functional group may have reactivity with respect to a liquid crystal, molecule of the liquid crystal layer or a precursor for forming the liquid crystal molecule. The reactive compound may induce an additional reaction other than the reaction inducing the liquid crystal aligning ability of the photo-alignment polymer in the mixture, such as the photo-dimerization during light irradiation for forming the alignment layer or forming the liquid crystal layer. Also, by controlling a weight ratio of the reactive compound and the photo-alignment polymer in the mixture, it is possible to control an average tilt angle of the liquid crystal molecule in the liquid crystal layer.

The additional reaction may include a crosslinking reaction between the photo-alignment polymers, a crosslinking reaction between the photo-alignment polymer and the reactive compound or between the liquid crystal molecule and the reactive compound, and a crosslinking reaction between the photo-alignment polymer and the liquid crystal molecule.

In the above, as the functional group capable of reacting with the photo-alignment polymer and/or liquid crystal molecule, a functional group that can be crosslinked with the photo-alignment polymer and/or liquid crystal molecule through free radical reactions and that include an ethylenically unsaturated double bond may be exemplified.

Specific examples of the functional group may include, but are not limited to, at least one or two kinds of an alkenyl group, an epoxy group, a cyano group, a carboxyl group, an acryloyl group or a methacryloyl group, preferably a vinyl group, an allyl group, an acryloyl group or a methacryloyl group, and more preferably an acryloyl group or a methacryloyl group.

In one embodiment, the reactive compound may include at least one of the functional group, preferably at least two of the functional groups, more preferably 2 to 10 of the functional groups, further preferably 4 to 10 of the functional groups, and most preferably 4 to 8 of the functional groups. The reactive compound may have a molecular weight or weight average molecular weight of 200 to 5,000, and preferably 200 to 1,000. Within the above range of the number of the functional groups, the molecular weight or weight average molecular weight, the compound may maintain the liquid crystal aligning ability of the photo-alignment polymer and also effectively induce the additional reaction, thereby improving durability of the liquid crystal film. Also, within the above range of the number of the functional groups, the molecular weight or weight average molecular weight, the compound may effectively control an average tilt angle of the liquid crystal molecule in the liquid crystal layer as well as maintaining the liquid crystal aligning ability of the photo-alignment polymer.

An example of the reactive compound may be, but is not limited to, alkyl (meth)acrylate such as methyl (meth)acrylate, ethyl (meth)acrylate, N,N-dimethylaminoethyl (meth)acrylate or 2-(2-oxo-imidazolidinyl)ethyl (meth)acrylate; hydroxyalkyl (meth)acrylate such as hydroxyethyl (meth)acrylate or hydroxypropyl (meth)acrylate; an alkoxyalkyl (meth)acrylate such as methoxyethyl (meth)acrylate; carboxyalkyl (meth)acrylate such as carboxyethyl (meth)acrylate; a multifunctional acrylate such as trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, triglycerol di(meth)acrylate, tripropyleneglycol di(meth)acrylate, tetraethyleneglycol di(meth)acrylate, pentaerythritol di(meth)acrylate, 1,6-hexanediol di(meth)acrylate, glycerol di(meth)acrylate, tris[2-(acryloyloxy)ethyl] isocyanurate, urethane acrylate, glycerol 1,3-diglycerolate di(meth)acrylate or tri(propyleneglycol) glycerolate diacrylate; alkenyl (meth)acrylate such as vinyl (meth)acrylate or allyl (meth)acrylate; alkoxy polyalkyleneglycol (meth)acrylate such as butoxy triethyleneglycol (meth)acrylate; succinic acid acryloyloxyalkyl ester such as mono-2-(acryloyloxy)ethyl succinate; (meth)acryloyloxyalkyl (meth)acrylate such as 3-(acryloyloxy)-2-hydroxypropyl (meth)acrylate; (meth)acrylamide or a derivative thereof such as diacetone (meth)acrylamide, N-[tris(hydroxymethyl)methyl]acrylamide, N,N-(1,2-dihydroxyethylene)bisacrylamide, N,N-(1,2-dihydroxyethylene)bisacrylamide or N,N-methylenebis(acrylamide); acetamidoacrylic acid alkyl ester such as methyl 2-acetamidoacrylate; a triazine substituted with (meth)acryloyl or alkenyl such as 1,3,5-triacryloylhexahydro-1,3,5-triazine or 2,4,6-triallyloxy-1,3,5-triazine; an isocyanurate substituted with an epoxy group such as tris(2,3-epoxypropyl) isocyanurate; tetracyanoalkylene oxide such as tetracyano ethylene oxide, a carboxylate substituted with an alkenyl group such as triallyl benzenetricarboxylate; caprolactone (meth)acryloyloxyalkyl ester such as carprolactone 2-((meth)acryloyloxy)ethyl ester, maleic acid (meth)acryloyloxyalkyl ester such as mono-2-((meth)acryloyloxy)ethyl malate, a polyvalent carboxylic acid such as 1,2,3-triazole-4,5-dicarboxylic acid, an alkanediol substituted with an alkenyl group such as 3-allyloxy-1,2-propanediol, an alkane substituted with a glycidyloxyphenyl group such as bis[4-(glycidyloxy)phenyl]methane, a dioxalene compound substituted with an alkenyl group such as 2-vinyl-1,3-dioxalene or poly(melamine-co-formaldehyde).

The term “(meth)acryl” used herein may mean an “acryl” or “methacryl.”

The above-mentioned reactive compound may be optionally substituted with at least one substitutent such as a halogen, a hydroxyl group, an epoxy group, an acryloyl group, a methacryloyl group, an isocyanate group, a thiol group, an alkoxy group or a monovalent hydrocarbon group.

In one embodiment, the reactive compound may be a multifunctional acrylate, and preferably a multifunctional acrylate such as pentaerythritol triacrylate, dipentaerythritol hexaacrylate, tris[2-(acryloyloxy)ethyl] isocyanurate or urethane acrylate, but is not limited thereto. Examples of the urethane acrylate may include, but is not limited to, a compound commercially available from Cytec under the name of EB 1290, UP135, UP 111 or UP128.

A photoinitiator may be any one capable of inducing a free radical reaction by light irradiation. The photoinitiator may be α-hydroxy ketone compound, α-amino ketone compound, phenyl glyoxylate compound or oxime ester compound, and preferably oxime ester compound.

The oxime ester compound exhibits excellent sensitivity even when low intensity light, for example, low intensity UV rays, is irradiated, and has excellent curing efficiency. The compound may exhibit excellent resistance with respect to various organic solvents, prevent erosion between the substrate and the liquid crystal layer, increase an interlayer binding ability, and induce stable alignment of liquid crystals. In addition, the photoinitiator may induce a crosslinking reaction between various components which will be described later, thereby improving the durability of the film.

The mixture for forming the alignment layer may include 0.1 to 20 parts by weight, and preferably 0.1 to 10 parts by weight of the photo-alignment polymer; 0.1 to 20 parts by weight, preferably 0.1 to 15 parts by weight, and more preferably 0.1 to 5 parts by weight of the reactive compound; and 0.01 to 5 parts by weight, and preferably 0.01 to 2 parts by weight of the photoinitiator.

In the above-mentioned weight ratio of the photo-alignment polymer, a favorable alignment layer having a suitable thickness may be obtained. Also, in the weight ratios of the reactive compound and the photoinitiator, the alignment of the alignment layer may be maintained and a suitable crosslinking reaction may be induced.

In one embodiment, the mixture may include 10 to 1,000 parts by weight, and preferably 25 to 400 parts by weight of the reactive compound, relative to 100 parts by weight of the photo-alignment polymer. In the above weight ratio, an adhesive strength to a substrate or liquid crystal layer and the alignment of the alignment layer may be excellently maintained. Particularly, as will be described later, when the ratio of the reactive compound is controlled within the above range, the average tilt angle of the liquid crystal molecule in the liquid crystal layer can be controlled. For example, when the weight ratio of the reactive compound is controlled, to 25 to 400 parts by weight, relative to 100 parts by weight of the photo-alignment polymer, the liquid crystal film may exhibit a suitable effect as a compensation film of an LCD device including a TN-mode liquid crystal panel.

In addition, the mixture may appropriately include various additives known in the art, if necessary, along with the above-mentioned components.

In one embodiment, the reaction product of the mixture may include a photo-dimerization reaction product of the photo-alignment polymer, along with at least one selected from the group consisting of a crosslinked product of the photo-alignment polymers, a crosslinked product of the photo-alignment polymer and the reactive compound, a crosslinked product of the reactive compounds, a crosslinked product of the liquid crystal molecule and the photo-alignment polymer and a crosslinked product of the liquid crystal molecule and the reactive compound. In the above, the crosslinked product of the photo-alignment polymers includes a reaction product in which the photo-alignment polymers are directly crosslinked, and a reaction product in which the photo-alignment polymers are crosslinked via the reactive compound, and the crosslinked product of the liquid crystal molecule and the photo-alignment polymer includes a reaction product in which the photo-alignment polymer and the liquid crystal molecule are directly crosslinked, and a reaction product in which the photo-alignment polymer and the liquid crystal molecule are crosslinked via the reactive compound.

If the above reaction products are included, the liquid crystal film may exhibit excellent durability. Said reaction product may be formed by blending the reactive compound and the photoinitiator in the mixture for forming the alignment layer.

While not limited in theory, if a polymer capable of photo-dimerizing such as the polymer including a cinnamate moiety is used as the photo-alignment polymer, the polymer may be aligned in a direction vertical to a polarized UV ray by the irradiation of the polarized UV ray. Conventionally, some of the polymers may be aligned as described above by the photo-dimerization and some of the polymers are present in unreacted or unaligned state. In the liquid crystal film, the reactive compound and the photoinitiator may be used to improve the adhesive strength between the substrate and the alignment layer and between the alignment layer and the liquid crystal layer using the unreacted or unaligned polymer, and ensure the durability. That is, if the reactive compound and the photoinitiator are included, a crosslinking reaction between reactive moieties, for example, cinnamate moieties, of the unreacted or unaligned polymer and/or a crosslinking reaction between the cinnamate moiety and a functional group of the reactive compound may be induced, and a crosslinking reaction between a liquid crystal molecule of the liquid crystal layer formed adjacent to the alignment layer with the cinnamate moiety or the functional group of the reactive compound may also be induced.

In the liquid crystal film, a kind of the liquid crystal layer formed on the alignment layer is not particularly limited.

In one embodiment, the liquid crystal layer may include a polymerizable liquid crystal compound in polymerized form. For example, the polymerizable liquid crystal compound may form a liquid crystal polymer by the light irradiation and exhibit a nematic or cholesteric liquid crystal phase.

In one embodiment, the polymerizable liquid crystal compound may be a compound having a functional group capable of being polymerized by the light irradiation, for example, an acrylate group. Specifically, the polymerizable liquid crystal compound may be one or a mixture of at least two of cyano biphenyl acrylate, cyano phenyl cyclohexane acrylate, cyano phenyl ester acrylate, benzoic acid phenyl ester acrylate and phenyl pyrimidine acrylate. Such a compound is a low-molecular weight liquid crystal showing a nematic or cholesteric liquid crystal phase at room temperature or high temperature.

In one embodiment, the liquid crystal molecule included in the liquid crystal layer may be aligned in a homogeneous, homeotropic, tilted, splay or cholesteric sate. In one embodiment, if the liquid crystal molecule is aligned in a splay sate, the average tilt angle may be 20 to 70 degrees. In the specification, the term “tilt angle” of the liquid crystal molecule may mean an angle between one of the aligned liquid crystal molecules and the surface of the substrate, and the term “average tilt angle” may mean an average value of the tilt angles or the alignment of the total liquid crystal molecules. As will be described later, the tilt angle may be controlled by adjusting a ratio of the reactive compound relative to the photo-alignment polymer in the mixture forming the alignment layer. In addition, the average tilt angle may be calculated by retardation value according to angles which can be measured by using an Axoscan that can be obtained from Axometrics and that is an instrument capable of measuring retardation value (e.g., produced by Axometrics) according to the manufacturer's manual.

The liquid crystal film may be used as a retardation film or viewing angle compensation film for a display device, or a protective film of a polarizer.

In one embodiment, if the liquid crystal film is used as a compensation film in an LCD device having a TN-mode liquid crystal panel, the liquid crystal film or liquid crystal layer may have optical anisotropy. In this case, the film or the layer may have an in-plane retardation (Rᵢₙ) of 20 to 200 nm, preferably 20 to 180 nm, and more preferably 30 to 150 nm.

In the specification, the in-plane retardation means a value calculated as in the following Equation 1.

Rᵢₙ=(X−Y)×D [Equation 1]

In Equation 1, X is a refractive index in a slow axis direction in the plane of the liquid crystal film or liquid crystal layer with respect to light having a wavelength of 550 nm. Y is a refractive index in a fast axis direction in the plane of the liquid crystal film or liquid crystal layer with respect to the light having a wavelength of 550 nm. D is a thickness of the liquid crystal film or liquid crystal layer.

The present invention also relates to a method of manufacturing a liquid crystal film. In one embodiment, the method may include: forming an alignment layer by applying a primary mixture including a photo-alignment polymer, a reactive compound having at least one functional group capable of reacting with the photo-alignment polymer and a photoinitiator to a substrate and reacting it; and forming a liquid crystal layer including a liquid crystal molecule by applying a secondary mixture including a polymerizable liquid crystal compound to the alignment layer, aligning and polymerizing the liquid crystal compound.

The present invention also relates to a method of controlling an average tilt angle of a liquid crystal molecule. In one embodiment, the method may include: forming an alignment layer by applying a primary mixture including a photo-alignment polymer, a reactive compound having at least one functional group capable of reacting with the photo-alignment polymer and a photoinitiator to a substrate and reacting it; and forming a liquid crystal layer including a liquid crystal molecule by applying a secondary mixture including a polymerizable liquid crystal compound to the alignment layer, aligning and polymerizing the liquid crystal compound. In the above method, a weight ratio of the reactive compound in the primary mixture may be controlled within a range of 10 to 1,000 parts by weight relative to 100 parts by weight of the photo-alignment polymer.

The primary mixture applied to the substrate to form the alignment layer may be prepared by uniformly mixing the photo-alignment polymer, the reactive compound and the photoinitiator in a suitable solvent. As a solvent, a conventional organic solvent may be used, and for example, at least one or two kinds of an ether solvent, an aromatic solvent, a halogen solvent, an olefin solvent or a ketone solvent may be used. Specifically, an example of the solvent may be cyclopentanone, cyclohexanone, chlorobenzene, N-methylpyrrolidone, toluene, xylene, mesitylene, cymene, dimethylsulfoxide, dimethylformamide, chloroform, gamma-butyrolactone or tetrahydrofuran.

The primary mixture may be applied to the substrate by a conventional coating method, for example, bar coating, comma coating or spin coating. The mixture may be applied to a thickness of 800 to 5,000 Å.

Following the application, the applied mixture may be dried under a suitable condition, and then light may be irradiated, thereby forming the alignment layer. In one embodiment, the drying may be performed by maintaining the applied primary mixture at approximately 25° C. to 150° C. for approximately 30 seconds. If the drying temperature is 25° C. or higher, a remaining solvent in the applied layer may be sufficiently dried, thereby preventing staining and suitably maintaining aligning performance. In addition, if the drying temperature is 150° C. or lower, transformation of the substrate may be prevented.

Following the drying process, an alignment layer may be formed by irradiating light, for example, a linearly-polarized UV ray. The light may be applied, for example, for 0.5 seconds or more. According to the light irradiation, the photo-alignment polymer may be aligned by photo-dimerization, and various crosslinking reactions described above may also be induced. Here, the irradiation of the linearly-polarized UV ray may be performed using a wire-grid polarizing plate. In this procedure, a polarizing direction of the UV ray is controlled to control an alignment direction of the alignment layer, and an optical axis of the applied polymerizable liquid crystal compound may also be controlled according to a purpose.

The liquid crystal layer may be formed by applying the secondary mixture including the polymerizable liquid crystal compound to the alignment layer, and aligning and polymerizing the liquid crystal compound. For example, the secondary mixture may be prepared by dissolving the polymerizable liquid crystal compound in a suitable solvent. Specifically, the secondary mixture may be prepared by dissolving the polymerizable liquid crystal compound and the photoinitiator in a solvent. In the secondary mixture, the polymerizable liquid crystal compound may be included in an amount of 5 to 70 parts by weight, and preferably, 5 to 50 parts by weight, relative to 100 parts by weight of the total secondary mixture. If the ratio of the polymerizable liquid crystal compound is 5 parts by weight or more, staining may be prevented, and if the ratio of the polymerizable liquid crystal compound is 70 parts by weight or less, precipitation of the polymerizable liquid crystal compound may be prevented.

A content of the photoinitiator included in the secondary mixture may be 3 to 10 parts by weight relative to 100 parts by weight of the polymerizable liquid crystal compound. If the weight ratio of the photoinitiator is 3 parts by weight or more, sufficient curing may be induced during the light irradiation, and if the weight ratio of the photoinitiator is 10 parts by weight or less, the alignment of the liquid crystal molecule may be suitably induced.

In addition to the above-mentioned components, a chiral agent, a surfactant, a polymerizable monomer and a polymer may be further added to the secondary mixture in a range not disturbing the alignment of the liquid crystal molecule.

In the preparation of the secondary mixture, a halogenated hydrocarbon such as chloroform, tetrachloroethane, trichloroethylene, tetrachloroethylene or chlorobenzene, an aromatic hydrocarbon such as benzene, toluene, xylene, mesitylene, cymene, methoxybenzene or 1,2-dimethoxybenzene, a ketone such as acetone, methylethylketone, cyclohexanone or cyclopentanone, an alcohol such as isopropyl alcohol or n-butanol, or a cellosolve such as methyl cellosolve, ethyl cellosolve or butyl cellosolve may be used as a solvent.

The secondary mixture including the polymerizable liquid crystal compound may be applied to the alignment layer, dried, aligned and then polymerized. The drying may be performed at approximately 25° C. to 120° C. for 1 minute. The drying temperature is a factor which can affect the alignment of the liquid crystal, and therefore, within the above-mentioned range, proper alignment of the liquid crystal molecule may be induced, and staining may be prevented.

Following the drying procedure, the liquid crystal compounds are polymerized by irradiating light, for example, a UV ray, to the applied layer. The polymerization may be performed under the presence of the photoinitiator absorbing a wavelength in the UV region. In addition, according to the light irradiation, the above-mentioned crosslinking reaction in the alignment layer may be induced.

The UV irradiation may be performed in the air or under a nitrogen atmosphere in which oxygen is blocked to increase reaction efficiency. As a UV irradiator, a middle- or high-pressure mercury UV lamp or metal halide lamp having an intensity of 80 w/cm or higher may be generally used. When necessary, during the UV irradiation, a cold mirror or another cooling apparatus may be equipped between the substrate and the UV lamp to maintain a surface temperature of the liquid crystal layer to be a liquid crystal state.

Meanwhile, in the method of controlling an average tilt angle, the ratio of the reactive compound in the primary mixture applied to form the alignment layer during the procedure may be controlled within a range of 10 to 1,000 parts by weight, and preferably 25 to 400 parts by weight relative to 100 parts by weight of the photo-alignment polymer.

According to the method, an optical characteristic of a liquid crystal film may be controlled in a wide range using such a simple method of controlling the ratio of the reactive compound to the photo-alignment polymer.

For example, when the ratio of the reactive compound to the photo-alignment polymer is decreased, an average tilt angle of the liquid crystal molecule is reduced, and when the ratio of the reactive compound is increased, the average tilt angle may be increased. While not limited in theory, the alignment of the liquid crystal molecule by the photo-alignment polymer is caused by, for example, interaction between a photo-dimerization product of the photo-alignment polymer and the liquid crystal molecule, and according to the ratio of the photo-dimerization product of the photo-alignment polymer, strength fixing the liquid crystal molecule is also changed. Therefore, it is understood that, by controlling the ratio of the reactive compound, the ratio of the photoreactive polymers or the photo-dimerized product thereof on a surface of the alignment layer may be controlled, and therefore the average tilt angle of the liquid crystal molecule may be controlled.

In still another embodiment, a liquid crystal display device that includes the liquid crystal film is provided.

The liquid crystal film may be useful as an optical compensation substrate for an LCD device, and therefore, may be included in the device as an optical compensation substrate. The film may also be used as a retardation film for a super twist nematic (STN) LCD, thin film transistor-twisted nematic (TFT-TN) LCD, vertical alignment (VA) LCD or in-plane switching (IPS) LCD, a λ/2 wavelength plate, a λ/4 wavelength plate, a reverse-wavelength dispersion film, an optical compensation film, a color filter, a laminated film with a polarizing plate or polarizer, or a compensation film for a polarizing plate.

The LCD device including the liquid crystal film will be exemplified as follows:

The LCD device may include a liquid crystal panel; and may further include first and second polarizing plates arranged on both sides of the liquid crystal panel, respectively. The liquid crystal film may be disposed between the liquid crystal panel and the first polarizing plate and/or between the liquid crystal panel and the second polarizing plate.

In the above, the first and/or second polarizing plates may include a protective film on one or both surfaces thereof. An example of the protective film may be a TAC (Triacetylcellulose) film, a polynorbonene film manufactured by ring opening metathesis polymerization (ROMP), a HROMP (ring opening metathesis polymerization followed by hydrogenation) polymer prepared by subjecting cycloolefin polymer (COP) that is ring-opening polymerized to hydrogenation, a polyester film, or a polynorbonene film manufactured by addition polymerization, and a film manufactured by using a transparent polymer may also be used as the protective film, but is not limited thereto.

In one embodiment, the liquid crystal film may be particularly useful in an LCD device including a TN-mode liquid crystal panel.

In still another embodiment, a polarizing plate including a polarizer, and the liquid crystal film formed on one or both surfaces of the polarizer may be provided.

In the polarizing plate, the liquid crystal film may serve as a protective film or compensation film, and preferably a protective film.

In case where the liquid crystal film is applied to the polarizing plate, a liquid crystal layer or substrate of the film may be in contact with the polarizer.

In another embodiment, the liquid crystal film is disposed only on one surface of the polarizer, and another optical film or protective film known in the art may be disposed on the other surface of the polarizer.

As the polarizer, for example, a polyvinylalcohol polarizer in which iodine or dichromic dye is adsorbed and aligned may be used.

The polarizer and the liquid crystal film may be laminated by a conventional method. For example, a method to adhere the protective film to the polarizer by using an adhesive or pressure-sensitive adhesive may be used. In this method, an adhesive or pressure-sensitive adhesive is coated on a suitable surface of the polarizer or liquid crystal film using a roll coater, a gravure coater, a bar coater, a knife coater or a capillary coater, and thereby the film and the polarizer are laminated by lamination under high or room temperature using a lamination roll. In case where a hot melt-type adhesive is used, a thermal pressure roll may be used.

As the adhesive or pressure-sensitive adhesive, a one or two part PVA adhesive, a polyurethane adhesive, an epoxy adhesive, a styrene butadiene rubber (SBR) adhesive or a hot melt adhesive may be used, but is not limited thereto.

If the polyurethane adhesive is used, polyurethane adhesive prepared using an aliphatic isocyanate compound which is not yellowed by light is preferably used. If one part or two part adhesive for dry lamination or an adhesive having a relatively low reactivity between an isocyanate and a hydroxyl group is used, a solution-type adhesive diluted with an acetate solvent, a ketone solvent, an ether solvent or an aromatic solvent may be used.

The adhesive or pressure-sensitive adhesive may have a low viscosity of about 5,000 cps or less. It is favorable for the adhesives to have good storage stability, and a transmit-light intensity of 90% or more at 400 to 800 nm.

As the pressure-sensitive adhesive, a pressure sensitive adhesive of which mechanical strength can be improved to a level of adhesive by sufficient curing induced by heat application or UV irradiation after the lamination is preferable. Also, it is favorable for the pressure sensitive adhesive to interfacial adhesion strength enough for the films to which the pressure-sensitive adhesives are attached not to be detached unless any one of them is destroyed.

An example of the pressure-sensitive adhesive may be a natural rubber, synthetic rubber or elastomer having excellent optical transparency, a vinyl chloride/vinyl acetic acid copolymer, a polyvinylalkylether-, polyacrylate- or modified polyolefin pressure-sensitive adhesive, or a curable pressure-sensitive adhesive in which a curing agent such as isocyanate is added to the above-mentioned materials.

In still another embodiment, a liquid crystal display device including the polarizing plate may be provided.

The polarizing plate may be used as the first or second polarizing plate having the above-mentioned structure.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIGS. 1 to 5 are graphs exhibiting retardation values according to viewing angles of liquid crystal films in Examples 7 to 11, respectively; and

FIG. 6 is a diagram exhibiting a contrast ratio of a liquid crystal display device using the liquid crystal film of Example 7.

### DETAILED DESCRIPTION OF EXEMPLARY EMBODIMENTS

Hereinafter, the present invention will be described in detail with respect to Examples according to the present invention and Comparative Examples not according to the present invention, but the scope of the present invention is not limited thereto.

In the following Examples, the mark “Mw” means a weight average molecular weight, the mark “Mn” means a number average molecular weight, and the mark “Tg” means a glass transition temperature.

### Example 1

### Manufacture of Substrate

A raw material pellet was prepared by providing a resin composition prepared by uniformly mixing 85 parts by weight of poly(N-cyclohexylmaleimide-co-methylmethacrylate)(content of N-cyclohexylmaleimide: 6.5 wt %, NMR analysis) and 15 parts by weight of a phenoxy resin(PKFE, InChemRez; Mw=60,000, Mn=16,000 and Tg=98° C.) to a 16 Φ extruder in which a space from a row material hopper to the extruder was substituted with nitrogen and melting the resin composition at 250° C. Subsequently, the row material pellet was vacuum-dried, melted using the extruder at 250° C., passed through a coat hanger-type T-die and passed through a chromium-plating casting roll and dry roll, thereby preparing an acrylic film having a thickness of 40 μm.

Formation of Alignment Layer and Alignment

An alignment layer was formed by preparing a liquid crystal alignment coating solution by dissolving 20 g of 5-norbonene-2-methyl-(4-methoxy cinnamate) as a photoreactive polymer, 20 g of dipentaerythritol hexaacrylate as a reactive compound and 5 g of a photoinitiator (Irgacure OXE02, Ciba-Geigy (Switzerland)) in 980 g of cyclopentanone; applying the coating solution to the prepared acrylic film so as to have a thickness of 1,000 Å after drying; and drying the coated coating solution using hot wind for 2 minutes in a 70° C. dry oven.

Subsequently, while being transferred in a predetermined direction, the acrylic film on which the alignment layer was formed was exposed once at a rate of 3 m/minute by irradiating a linearly polarized UV ray that has a polarized direction perpendicular to the film transferring direction by means of a wire grid polarizing plate (Moxtek) using a high pressure mercury lamp (80 w/cm) as a light source to provide the aligning ability.

Formation of Liquid Crystal Layer

A polymerizable liquid crystal coating solution was prepared by dissolving a mixture including 95 parts by weight of a polymerizable liquid crystal compound (Merck) that included cyanobiphenyl acrylate, cyanophenyl cyclohexane acrylate and cyanophenylester acrylate and that was capable of being homogeneously aligned and 5 parts by weight of a photoinitiator (Irgacure 907, Ciba-Geigy (Switzerland)) in toluene that is solvent so as to have 25 parts by weight of a solid contents relative to 100 parts by weight of the total solution.

The prepared liquid crystal coating solution was applied to the aligned liquid crystal alignment layer so as to have a thickness of 1 μm after drying, and dried by hot wind in a 60° C. dry oven for 2 minutes. Afterward, a liquid crystal film was formed by curing the coated coating solution by irradiating it with unpolarized UV ray using a high pressure mercury lamp (80 w/cm).

The prepared liquid crystal film is a laminated optical film including an acrylic film, the liquid crystal alignment layer formed on the film and the liquid crystal layer formed on the liquid crystal alignment layer.

### Example 2

A liquid crystal film was manufactured by the same method as in Example 1, except that a polymerizable liquid crystal compound (Merck) that was capable of being splay aligned and that included cyanobiphenyl acrylate, cyanophenylcyclohexane acrylate and cyanophenylester acrylate was used instead of the polymerizalbe liquid crystal compound that was capable of being homogeneous aligned and that included cyanobiphenyl acrylate, cyanophenyl cyclohexane acrylate and cyanophenyl ester acrylate.

### Example 3

A liquid crystal film was manufactured by the same method as in Example 1, except that a polymerizable liquid crystal compound (Merck) that was capable of being cholesteric aligned and included cyanobiphenyl acrylate, cyanophenylcyclohexane acrylate, cyanophenylester acrylate, benzoic acid phenyl ester acrylate and phenyl pyrimidine acrylate was used instead of the polymerizalbe liquid crystal compound that was capable of being homogeneous aligned and that included cyanobiphenyl acrylate, cyanophenyl cyclohexane acrylate and cyanophenyl ester acrylate.

### Example 4

A liquid crystal film was manufactured by the same method as in Example 1, except that a liquid crystal alignment layer coating solution prepared by dissolving 20 g of 5-norbonene-2-methyl-(4-methoxy cinnamate) as a photoreactive polymer, 20 g of dipentaerythritol hexaacrylate and 5 g of a photoinitiator (Irgacure 907, Ciba-Geigy (Switzerland)) in 980 g of cyclopentanone was used.

### Example 5

A liquid crystal film was manufactured by the same method as in Example 2, except that a liquid crystal alignment layer coating solution prepared by dissolving 20 g of 5-norbonene-2-methyl-(4-methoxy cinnamate) as a photoreactive polymer, 20 g of dipentaerythritol hexaacrylate and 5 g of a photoinitiator (Irgacure 907, Ciba-Geigy (Switzerland)) in 980 g of cyclopentanone was used.

### Example 6

A liquid crystal film was manufactured by the same method as in Example 3, except that a liquid crystal alignment layer coating solution prepared by dissolving 20 g of 5-norbonene-2-methyl-(4-methoxy cinnamate) as a photoreactive polymer, 20 g of dipentaerythritol hexaacrylate and 5 g of a photoinitiator (Irgacure 907, Ciba-Geigy (Switzerland)) in 980 g of cyclopentanone was used.

### Experimental Example 1

### Evaluation of Aligning Ability and Adhesion Property

Aligning property, adhesion property between the substrate and the alignment layer and adhesion property between the alignment layer and the liquid crystal layer of the liquid crystal films in Examples 1 to 6 were evaluated, and the results are shown in Table 1.

The aligning property was evaluated by positioning the liquid crystal film between two polarizer of which light absorbance axes were perpendicular to each other, irradiating light from one side thereof, and observing retardation and retardation uniformity exhibited by the liquid crystal film. According to the above method, the case where no alignment occurred was evaluated as “X,” the case where alignment occurred with some deviation was evaluated as “Δ,” and the case where alignment occurred without deviation was evaluated as “o.”

In addition, the adhesion properties were evaluated by cross-cutting the surface of the liquid crystal film in a 1-mm checker figure using a cutter, attaching a cellophane tape to the surface of the liquid film and then detaching the cellophane tape at the same rate and angle according to the ASTM specification. The case where neither the liquid crystal layer nor the alignment layer was detached was evaluated as “o,” and the case where the liquid crystal layer was detached from the alignment layer or the alignment crystal layer was detached from the substrate was evaluated as “Δ” or “X.” In the above, if the detached area was 5% or less of the total area, the adhesion property was classified as “Δ,” and if the detached area was larger than 5%, the adhesion property was evaluated as “X.”

TABLE 1

| | | Examples | | | | | |
|---|---|---|---|---|---|---|---|
| | | 1 | 2 | 3 | 4 | 5 | 6 |
| Aligning property | | ∘ | ∘ | ∘ | Δ | Δ | Δ |
| Adhesion | Substrate and | ∘ | ∘ | ∘ | Δ | Δ | Δ |
| property | Alignment Layer | | | | | | |
| | Alignment Layer and | ∘ | ∘ | ∘ | Δ | Δ | Δ |
| | Liquid Crystal Layer | | | | | | |

### Experimental Example 2

### Evaluation of Thermal Stability of the Aligning Ability

The thermal stability of the aligning ability was evaluated by evaluating the aligning and adhesion properties after leaving the alignment layer obtained by irradiating with the polarized UV ray in any one of Examples 1 to 6 in a 100° C. dry oven for 48 hours and applying and aligning the polymerizable liquid crystal compound on the alignment layer.

A method and evaluation standards of the aligning ability and adhesion properties were the same as Experimental Example 1.

TABLE 2

| | | Examples | | | | | |
|---|---|---|---|---|---|---|---|
| | | 1 | 2 | 3 | 4 | 5 | 6 |
| Aligning property | | ∘ | ∘ | ∘ | Δ | Δ | Δ |
| Adhesion | Substrate and | ∘ | ∘ | ∘ | Δ | Δ | Δ |
| property | Alignment Layer | | | | | | |
| | Alignment Layer and | ∘ | ∘ | ∘ | Δ | Δ | Δ |
| | Liquid Crystal Layer | | | | | | |

### Example 7

A liquid crystal alignment layer coating solution was prepared by uniformly mixing 94.5 parts by weight of cyclopentanone as a solvent, 1 part by weight of 5-noboene-2-methyl-(4-methoxy cinnamate), 4 parts by weight of dipentaerythritol hexaacrylate and 0.5 parts by weight of a photoinitiator (Irgacure OXE02, Ciba-Geigy (Switzerland)).

A liquid crystal alignment layer was formed by applying the prepared coating solution to the acrylic film prepared in Example 1 so as to have a thickness after drying of 1,000 Å and drying it by hot wind in a 70° C. dry oven for 2 minutes.

Subsequently, while being transferred in a predetermined direction, the acrylic film on which the alignment layer was formed was exposed once at a rate of 3 m/minute by irradiating a linearly polarized UV ray that has a polarized direction perpendicular to the film transferring direction by means of a wire grid polarizing plate (Moxtek) using a high pressure mercury lamp (80 w/cm) as a light source to provide the aligning ability.

A liquid crystal film was manufactured by applying a polymerizable liquid crystal compound coating solution (solvent: toluene) that included 25 parts by weight of a solid content relative to 100 parts by weight of the total solution and that included 95 parts by weight of a polymerizable liquid crystal compound (Merck) that was capable of being splay aligned and that included cyanobiphenyl acrylate, cyanophenyl cyclohexane acrylate and cyanophenylester acrylate and 5 parts by weight of a photoinitiator (Irgacure 907, Ciba-Geigy (Switzerland)) to the aligned alignment layer so as to have a thickness after drying of 1 μm, drying it by hot wind in a 60° C. dry oven for 2 minutes, and curing the coated coating solution by irradiating with unpolarized UV rays using a high pressure mercury lamp (80 w/cm).

The prepared liquid crystal film is a laminated optical film including the acrylic film, the liquid crystal formed on the film and the liquid crystal film formed on the liquid crystal alignment layer.

### Example 8

A liquid crystal film was manufactured by the same method as in Example 7, except that a liquid crystal alignment layer coating solution prepared by uniformly mixing 95 parts by weight of cyclopentanone as a solvent, 1.5 parts by weight of 5-norbonene-2-methyl-(4-methoxy cinnamate), 3 parts by weight of dipentaerythritol hexaacrylate and 0.5 parts by weight of a photoinitiator (Irgacure OXE02, Ciba-Geigy (Switzerland)) was used.

### Example 9

A liquid crystal film was manufactured by the same method as in Example 7, except that a liquid crystal alignment layer coating solution prepared by uniformly mixing 94.5 parts by weight of cyclopentanone as a solvent, 2.5 parts by weight of 5-norbonene-2-methyl-(4-methoxy cinnamate), 2.5 parts by weight of dipentaerythritol hexaacrylate and 0.5 parts by weight of a photoinitiator (Irgacure OXE02, Ciba-Geigy (Switzerland)) was used.

### Example 10

A liquid crystal film was manufactured by the same method as in Example 7, except that a liquid crystal alignment layer coating solution prepared by uniformly mixing 95 parts by weight of cyclopentanone as a solvent, 3 parts by weight of 5-norbonene-2-methyl-(4-methoxy cinnamate), 1.5 parts by weight of dipentaerythritol hexaacrylate and 0.5 parts by weight of a photoinitiator (Irgacure OXE02, Ciba-Geigy (Switzerland)) was used.

### Example 11

A liquid crystal film was manufactured by the same method as in Example 7, except that a liquid crystal alignment layer coating solution prepared by uniformly mixing 94.5 parts by weight of cyclopentanone as a solvent, 4 parts by weight of 5-norbonene-2-methyl-(4-methoxy cinnamate), 1 part by weight of dipentaerythritol hexaacrylate and 0.5 parts by weight of a photoinitiator (Irgacure OXE02, Ciba-Geigy (Switzerland)) was used.

### Experimental Example 3

### Measurement of Average Tilt Angle

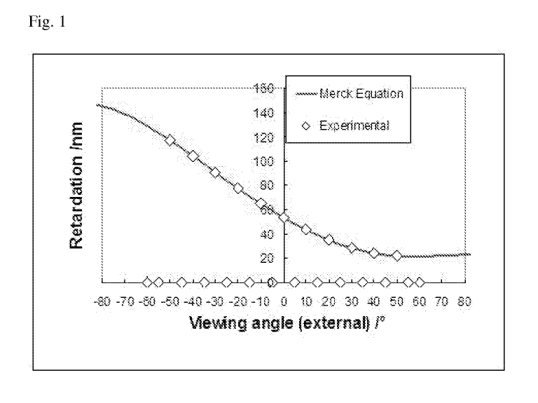

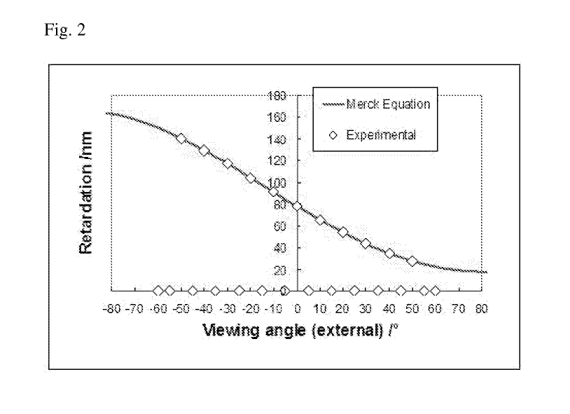

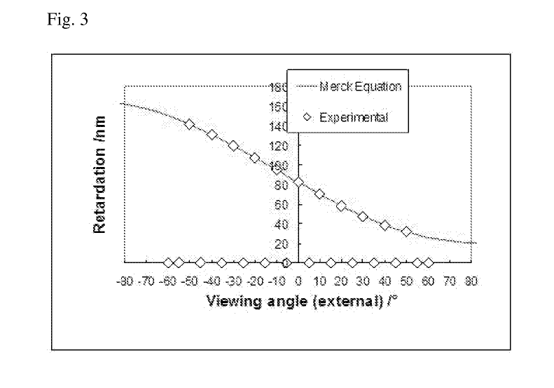

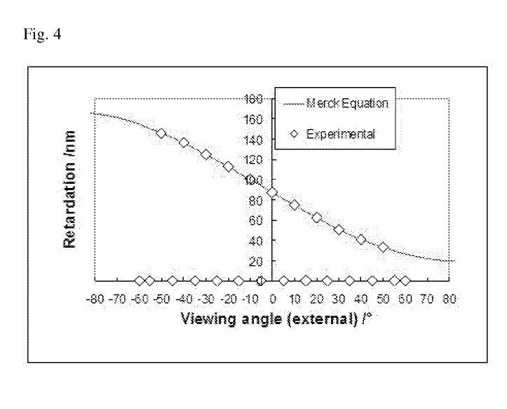

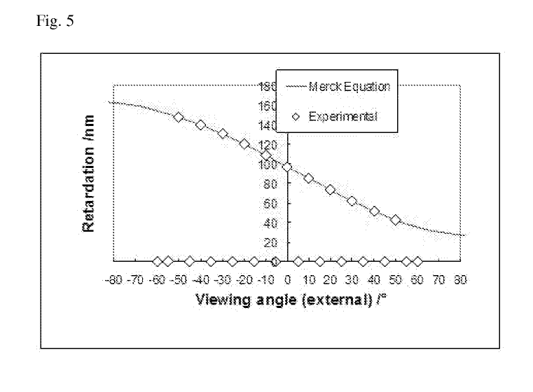

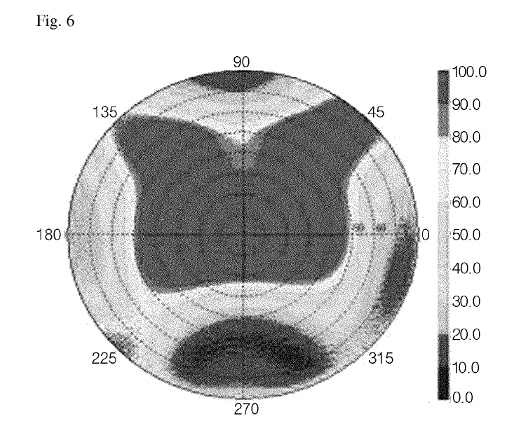

Retardation values according to viewing angles of the liquid crystal films of Examples 7 to 11 were measured, and an average tilt angle of the liquid crystal layer of the liquid crystal film was calculated using the Merk Equation. In the above, the retardation value was measured according to the manufacturer's manual, using Axoscan (Axometrics), and the results are shown in FIGS. 1 to 5. In addition, the calculated average tilt angles of the respective films are listed in Table 3.

TABLE 3

| | Examples | | | | |
|---|---|---|---|---|---|
| | 7 | 8 | 9 | 10 | 11 |
| Average Tilt Angle(Unit: Degree) | 52.3 | 39.5 | 37.3 | 35.4 | 30.3 |

From the results of Table 3, it can be confirmed that the average tilt angle of the liquid crystal layer of the liquid crystal film can be controlled by controlling a ratio of the photo-alignment polymer and the reactive compound and therefore the liquid crystal film having a suitable property according to the use of the liquid crystal film can be provided.

### Experimental Example 4

### Measurement of Contrast Ratio

The film of Example 7 was equipped to a 90-degree twisted LCD (TN-LCD) device in which a cell gap was 4.5 μm and a nematic liquid crystal having refractive indexes ne and no were respectively 1.6 and 1.5 measured with respect to light of a wavelength of 550 nm, and a contrast ratio was evaluated in a viewing angle range including a tilt angle of 0 to 80 degrees and radial angle of 0 to 360 degrees. Brightness in bright and dark states of a panel were respectively measured using ELDIM equipment, which can measure brightness and color of the panel, and therefrom the contrast ratio was measured. The measurement result is shown in Table 6. As shown in Table 6, it can be confirmed that, using the liquid crystal film according to the present invention, the contrast ratio was improved, and was excellent at 10:1 or more at all viewing angles (tilt angle: 0 to 80 degrees and radial angle: 0 to 360 degrees).

A liquid crystal film that has excellent properties including durability and an optical property and is capable of being effectively used for various purposes can be provided. In addition, the physical property of the liquid crystal film can be freely controlled according to a desired use.

While the invention has been shown and described with reference to predetermined exemplary embodiments thereof, it will be understood by those skilled in the art that various changes in form and details may be made therein without departing from the spirit and scope of the invention as defined by the appended claims.

What is claimed is:

1. A liquid crystal film, comprising:
a substrate;
an alignment layer that is present on the substrate and that is a reaction product of a mixture comprising a photo-alignment polymer, a reactive compound having at least one functional group capable of reacting with the photo-alignment polymer and a photoinitiator; and
a liquid crystal layer that is present on the alignment layer and that comprises a liquid crystal molecule.

2. The liquid crystal film according to claim 1, wherein the substrate is an acrylic substrate, a cycloolefin polymer substrate, a cellulose substrate or a polycarbonate substrate.

3. The liquid crystal film according to claim 2, wherein the acrylic substrate comprises an acrylic polymer having a (meth)acrylic monomer in polymerized form.

4. The liquid crystal film according to claim 3, wherein the acrylic polymer further comprises, in polymerized form, an aromatic vinyl monomer, an acid anhydride or a cyclic monomer.

5. The liquid crystal film according to claim 3, wherein the acrylic substrate further comprises at least one selected from the group consisting of an aromatic resin having an aromatic backbone and a hydroxyl group; a styrene resin; and a copolymer of a styrene monomer and a cyclic monomer.

6. The liquid crystal film according to claim 5, wherein the aromatic resin comprises a unit represented by the following Formula 3: 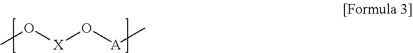
wherein X is a bivalent moiety induced from an aromatic compound, and A is an alkylene group or an alkylidene group substituted with at least one hydroxyl group.

7. The liquid crystal film according to claim 1, wherein the photo-alignment polymer exhibits the liquid crystal aligning ability through photo-dimerization by irradiation with a polarized UV ray.

8. The liquid crystal film according to claim 1, wherein the photo-alignment polymer is a photoreactive norbonene polymer having a cinnamate moiety, a photoreactive polymer having a unit represented by the following Formula 16 or a photoreactive polymer having a unit represented by the following Formula 17: 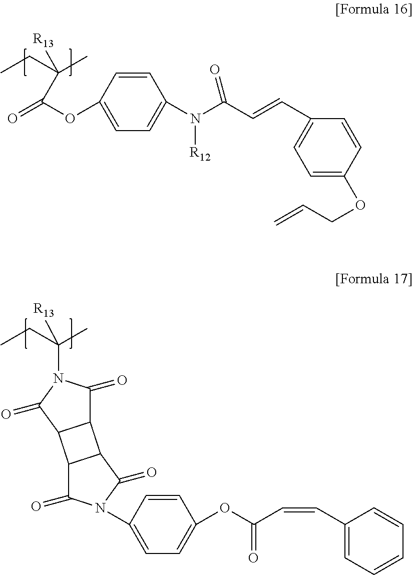
wherein R₁₂ and R₁₃ are independently hydrogen or an alkyl group.

9. The liquid crystal film according to claim 8, wherein the photoreactive polymer has a number average molecular weight of 10,000 g/mol to 500,000 g/mol.

10. The liquid crystal film according to claim 1, wherein the photo-alignment polymer comprises a unit represented by the following Formula 18: 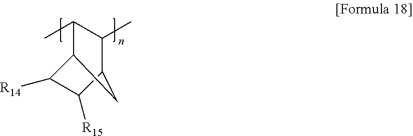
wherein n is a number of 50 to 5,000, R₁₄ and R¹⁵ are independently hydrogen, a halogen, an alkyl group or a moiety represented by the following Formula 19, provided that at least one of R₁₄ and R₁₅ being the moiety represented by the following Formula 19: 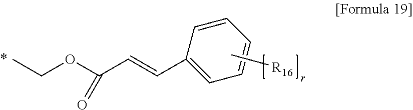
wherein R₁₆ is independently hydrogen, a halogen, an alkyl group, an alkoxy group and an allyloxy group, and r is a number of 1 to 5 which is a number of R₁₆ present in the benzene ring.

11. The liquid crystal film according to claim 1, wherein the functional group of the reactive compound is an alkenyl group, an epoxy group, a cyano group, a carboxyl group, an acryloyl group or a methacryloyl group.

12. The liquid crystal film according to claim 1, wherein the reactive compound comprises at least two functional groups capable of reacting with a photo-alignment polymer and has a molecular weight or weight average molecular weight of 200 to 5,000.

13. The liquid crystal film according to claim 1, wherein the reactive compound is an alkyl (meth)acrylate; a hydroxyalkyl (meth)acrylate; alkoxyalkyl (meth)acrylate; carboxyalkyl (meth)acrylate; a multifunctional acrylate; alkenyl (meth)acrylate; an alkoxy polyalkyleneglycol (meth)acrylate; succinic acid acryloyloxyalkyl ester; (meth)acryloyloxyalkyl (meth)acrylate; (meth)acrylamide; (meth)acrylamide derivative; an acetamidoacrylic acid alkyl ester; a triazine substituted with a (meth)acryloyl or alkenyl group; an isocyanurate substituted with an epoxy group; tetracyanoalkylene oxide, a carboxylate substituted with an alkenyl group; caprolactone (meth)acryloyloxyalkyl ester, maleic acid (meth)acryloyloxyalkyl ester, a polyvalent carboxylic acid, an alkane diol substituted with an alkenyl group, an alkane substituted with a glycidyloxyphenyl group, a dioxalene compound substituted with an alkenyl group or poly(melamine-co-formaldehyde).

14. The liquid crystal film according to claim 1, wherein the photoinitiator is an α-hydroxy ketone compound, an α-amino ketone compound, a phenyl glyoxylate compound or an oxime ester compound.

15. The liquid crystal film according to claim 1, wherein the photoinitiator is an oxime ester compound.

16. The liquid crystal film according to claim 1, wherein the mixture comprises 0.1 to 20 parts by weight of the photo-alignment polymer; 0.1 to 20 parts by weight of the reactive compound; and 0.01 to 5 parts by weight of the photoinitiator.

17. The liquid crystal film according to claim 1, wherein the mixture comprises 10 to 1,000 parts by weight of the reactive compound relative to 100 parts by weight of the photo-alignment polymer.

18. The liquid crystal film according to claim 1, wherein the reaction product comprises a photo-dimerization product of the photo-alignment polymers; and further comprises at least one selected from the group consisting of a crosslinked product of the photo-alignment polymer, a crosslinked product of the photo-alignment polymer and the reactive compound, a crosslinked product of the reactive compounds, a crosslinked product of the liquid crystal molecule and the photo-alignment polymer and a crosslinked product of the liquid crystal molecule and the reactive compound.

19. The liquid crystal film according to claim 1, wherein the liquid crystal layer comprises a polymerizable liquid crystal compound in polymerized form, the liquid crystal compound exhibiting a nematic or cholesteric liquid crystal phase.

20. The liquid crystal film according to claim 1, wherein the liquid crystal layer comprises at least one polymerizable liquid crystal compound selected from the group consisting of cyanobiphenyl acrylate, cyanophenyl cyclohexane acrylate, cyanophenyl ester acrylate, benzoic acid phenyl ester acrylate and phenyl pyrimidine acrylate in polymerized form.

21. The liquid crystal film according to claim 1, wherein the liquid crystal molecule is homogeneous aligned molecule, homeotropic aligned molecule, tilted aligned molecule, splay aligned molecule or cholesteric aligned molecule.

22. The liquid crystal film according to claim 21, wherein the splay aligned liquid crystal molecule has an average tilt angle of 20 to 70 degrees.

23. A method of manufacturing a liquid crystal film, comprising:
forming an alignment layer by applying and reacting a primary mixture comprising a photo-alignment polymer, a reactive compound having at least one functional group capable of reacting with the photo-alignment polymer and a photoinitiator on a substrate; and
forming a liquid crystal layer comprising a liquid crystal molecule by applying a secondary mixture comprising a polymerizable liquid crystal compound to the alignment layer and aligning and polymerizing it.

24. A method of controlling an average tilt angle of a liquid crystal molecule, comprising:
forming an alignment layer by applying and reacting a primary mixture comprising a photo-alignment polymer, a reactive compound having at least one functional group capable of reacting with the photo-alignment polymer and a photoinitiator on a substrate; and
forming a liquid crystal layer comprising a liquid crystal molecule by applying a secondary mixture comprising a polymerizable liquid crystal compound to the alignment layer and aligning and polymerizing it,
wherein a ratio of the reactive compound in the primary mixture is controlled within a range of 10 to 1,000 parts by weight relative to 100 parts by weight of the photo-alignment polymer.

25. The method according to claim 24, wherein the ratio of the reactive compound is controlled within a range of 25 to 400 parts by weight relative to 100 parts by weight of the photo-alignment polymer.

26. A liquid crystal display device that comprises the liquid crystal film of claim 1.

27. The liquid crystal display device according to claim 26, wherein the liquid crystal film is an optical compensation substrate.

28. The liquid crystal display device according to claim 26, which includes a TN-mode liquid crystal panel.

29. A polarizing plate, comprising:
a polarizer; and the liquid crystal film of claim 1 formed on one or both sides of the polarizer.
